(19) United States
(12) Patent Application Publication
(10) Pub. No.: US 2022/0145022 A1
(43) Pub. Date: May 12, 2022

(54) METHODS OF MAKING FILMS HAVING TARGET BETA RATIOS AND TARGET PERMEABILITIES

(71) Applicant: Dow Global Technologies LLC, Midland, MI (US)

(72) Inventors: Justice Alaboson, Pearland, TX (US); Jill M. Martin, Pearland, TX (US)

(21) Appl. No.: 17/432,440

(22) PCT Filed: Mar. 17, 2020
(86) PCT No.: PCT/US2020/023161

§ 371 Date: Aug. 19, 2021

Related U.S. Application Data
(60) Provisional application No. 62/821,275, filed on Mar. 20, 2019.

(51) Int. Cl. C08J 5/18; B32B 27/08; B32B 27/32; B32B 27/20; B65B 5/02

(52) U.S. Cl. CPC C08J 5/18; B32B 27/08; B32B 27/32; C08K 3/04; B65B 5/02; C08J 2323/06; B32B 27/20

(57) ABSTRACT

The present invention provides methods of making films and methods of making packages. In one aspect, a method of making a film having a beta ratio and a permeability comprises: (a) selecting a polyolefin, the polyolefin comprising low density polyethylene, linear low density polyethylene, medium density polyethylene, high density polyethylene, polypropylene, polyolefin elastomer, polyolefin plastomer, or a combination thereof; (b) identifying a target beta ratio and a target oxygen permeability for the film; (c) selecting one or more additives based on the target beta ratio, the one or more additives comprising calcium carbonate, carbon black, ethylene vinyl acetate, or a combination thereof; (d) determining an amount of the selected additive(s) based on the target beta ratio and the target oxygen permeability; and (e) forming a film comprising the polyolefin and the selected additive(s), wherein the film has the target beta ratio and the target oxygen permeability.

### FIELD

The present invention relates to methods of making films having target beta ratios and target permeabilities, and to methods of making packages.

### INTRODUCTION

One way to extend the shelf life of respiring produce such as fruits and vegetables is by employing controlled or modified atmosphere packaging. For controlled atmosphere packaging (CAP), the target is to maintain the right balance of carbon dioxide (CO₂) vs oxygen (O₂) concentration around the produce in order to slow down ripening and minimize anaerobic decay.

Most polyolefins used in flexible packaging have a CO₂/O₂ permeability ratio (“beta ratio”) that falls within a narrow range. A tunable CAP is often desired because each type of produce requires an optimum CO₂ vs. O₂ concentration for an extended shelf life. One way CAP is achieved is by controlling the relative transmission of CO₂ and O₂ through the package. Unmodified polyolefin-based packages or bags are limited in their ability to provide CAP. In addition, these packages tend to have low gas permeabilities, and to suffer from excess condensation of water, which promotes decay. One advancement over an unmodified package is the creation of micro-perforations in the film. The high permeabilities of such films can remove excessive buildup of CO₂ within the package and restore O₂ levels. However, this high permeability comes with the loss of humidity control, and the inability to sufficiently maintain the atmosphere at a given CO₂ vs. O₂ target.

It would be desirable to have the ability to achieve high and tunable beta Ratios in polyolefin-based films for controlled atmosphere packages.

### SUMMARY

The present invention provides methods of making films that have a target beta ratio and a target oxygen permeability. The incorporation of certain additives discussed herein has been found to provide both high and tunable beta ratios (e.g., up to twice the beta ratio of neat polyethylene) in polyolefin films. The enhancement of the beta ratio is achieved through increased solubility of CO₂ in the polyolefin relative to O₂ with the addition of these additives. In addition, in some embodiments, the use of two or more of these additives having different effects on film permeability can be simultaneously employed in a film to enable the beta ratio and permeability of the film to be independently tuned.

In one aspect, a method of making a film having a beta ratio and a permeability comprises (a) selecting a polyolefin, the polyolefin comprising polyethylene, polypropylene, polyolefin elastomer, polyolefin plastomer, or a combination thereof; (b) identifying a target beta ratio and a target oxygen permeability for the film; (c) selecting one or more additives based on the target beta ratio, the one or more additives comprising calcium carbonate, carbon black, ethylene vinyl acetate, or a combination thereof; (d) determining an amount of the selected additive(s) based on the target beta ratio and the target oxygen permeability; and (e) forming a film comprising the polyolefin and the selected additive(s), wherein the film has the target beta ratio and the target oxygen permeability.

The present disclosure also relates to methods of making packages. In one aspect, a method of making a package comprises (a) selecting a polyolefin, the polyolefin comprising polyethylene, polypropylene, polyolefin elastomer, polyolefin plastomer, or a combination thereof; (b) identifying a target beta ratio and a target oxygen permeability for a film; (c) selecting one or more additives based on the target beta ratio and the target oxygen permeability, the one or more additives comprising calcium carbonate, carbon black, ethylene vinyl acetate, or a combination thereof; (d) determining an amount of the selected additive(s) based on the target beta ratio and the target oxygen permeability; (e) forming a film comprising the polyolefin and the selected additive(s), wherein the film has the target beta ratio and the target oxygen permeability; and (f) forming a package comprising at least a portion of the film.

These and other embodiments are described in more detail in the Detailed Description.

### DETAILED DESCRIPTION

Unless specified otherwise herein, percentages are weight percentages (wt %) and temperatures are in ° C.

The term “composition,” as used herein, refers to a mixture of materials which comprises the composition, as well as reaction products and decomposition products formed from the materials of the composition.

“Polymer” means a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities (for example, catalyst residues) may be incorporated into and/or within the polymer. A polymer may be a single polymer, a polymer blend or a polymer mixture, including mixtures of polymers that are formed in situ during polymerization.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The terms “olefin-based polymer” or “polyolefin”, as used herein, refer to a polymer that comprises, in polymerized form, a majority amount of olefin monomer, for example ethylene or propylene (based on the weight of the polymer), and optionally may comprise one or more comonomers.

The term, “ethylene/α-olefin interpolymer,” as used herein, refers to an interpolymer that comprises, in polymerized form, a majority amount (>50 mol %) of units derived from ethylene monomer, and the remaining units derived from one or more α-olefins. Typical α-olefins used in forming ethylene/α-olefin interpolymers are C₃-C₁₀ alkenes.

The term, “ethylene/α-olefin copolymer,” as used herein, refers to a copolymer that comprises, in polymerized form, a majority amount (>50 mol %) of ethylene monomer, and an α-olefin, as the only two monomer types.

The term “α-olefin”, as used herein, refers to an alkene having a double bond at the primary or alpha (a) position.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

“Polyethylene” or “ethylene-based polymer” shall mean polymers comprising a majority amount (>50 mol %) of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); High Density Polyethylene (HDPE); and other ethylene-based polymers (e.g., enhanced polyethylene) having a density from 0.870 to 0.970 g/cm³. These polyethylene materials are generally known in the art; however, the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homo-polymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm³.

The term “LLDPE”, includes both resin made using the traditional Ziegler-Natta catalyst systems and chromium-based catalyst systems as well as single-site catalysts, including, but not limited to, bis-metallocene catalysts (sometimes referred to as “m-LLDPE”) and constrained geometry catalysts, and includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or 5,854,045). The LLDPEs can be made via gas-phase, solution-phase or slurry polymerization or any combination thereof, using any type of reactor or reactor configuration known in the art.

The term “MDPE” refers to polyethylenes having densities from 0.926 to 0.935 g/cm³. “MDPE” is typically made using chromium or Ziegler-Natta catalysts or using single-site catalysts including, but not limited to, bis-metallocene catalysts and constrained geometry catalysts, and typically have a molecular weight distribution (“MWD”) greater than 2.5.

The term “HDPE” refers to polyethylenes having densities greater than about 0.935 g/cm³ and up to about 0.970 g/cm³, which are generally prepared with Ziegler-Natta catalysts, chrome catalysts or single-site catalysts including, but not limited to, bis-metallocene catalysts and constrained geometry catalysts.

The term “ULDPE” refers to polyethylenes having densities of 0.880 to 0.912 g/cm³, which are generally prepared with Ziegler-Natta catalysts, chrome catalysts, or single-site catalysts including, but not limited to, bis-metallocene catalysts and constrained geometry catalysts. ULDPEs include, but are not limited to, polyethylene (ethylene-based) plastomers and polyethylene (ethylene-based) elastomers.

“Blend”, “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend. Such blends can be prepared as dry blends, formed in situ (e.g., in a reactor), melt blends, or using other techniques known to those of skill in the art.

“Polypropylene” shall mean polymers comprising a majority amount (>50 mol %) of units derived from propylene monomer. This includes polypropylene homopolymers or copolymers (meaning units derived from two or more comonomers). Common forms of polypropylene known in the art include homopolymer polypropylene (hPP), random copolymer polypropylene (rcPP), impact copolymer polypropylene (hPP+at least one elastomeric impact modifier) (ICPP) or high impact polypropylene (HIPP), high melt strength polypropylene (HMS-PP), isotactic polypropylene (iPP), syndiotactic polypropylene (sPP), and combinations thereof.

The present invention relates generally to methods of making polyolefin films. The incorporation of certain additives into polyolefin films has been found to provide high and tunable beta ratios in polyolefin films. In addition, the use of two or more of these additives having different effects on film permeability can be simultaneously employed in a film to enable the beta ratio and permeability of the film to be independently tuned. Thus, in some embodiments, methods of the present invention facilitate identify a target oxygen permeability and target beta ratio, and providing a film having such properties. Such embodiments advantageously permit a film or package manufacturer to tune the barrier properties of its films or packages depending on the product to be packaged.

In one embodiment, a method of making a film having a beta ratio and a permeability comprises: (a) selecting a polyolefin, the polyolefin comprising polyethylene, polypropylene, polyolefin elastomer, polyolefin plastomer, or a combination thereof; (b) identifying a target beta ratio and a target oxygen permeability for the film; (c) selecting one or more additives based on the target beta ratio, the one or more additives comprising calcium carbonate, carbon black, ethylene vinyl acetate, or a combination thereof; (d) determining an amount of the selected additive(s) based on the target beta ratio and the target oxygen permeability; and (e) forming a film comprising the polyolefin and the selected additive(s), wherein the film has the target beta ratio and the target oxygen permeability. In some embodiments, the film is a monolayer film. In some embodiments, the film is a multilayer film, and the additives are disposed in a single layer. In some embodiments, the film is a multilayer film, and the additives are disposed in at least two layers.

In some embodiments, the additive is calcium carbonate, the film comprises 10 to 40 weight percent calcium carbonate, and the film has a beta ratio from 1.5 to 3.0 (measured at 0% relative humidity (also referred to herein as “0% RH”)). In some such embodiments, such a film comprising 10 to 40 weight percent calcium carbonate further comprises a vinyl acetate content of 5 to 30 weight percent, and the film has a beta ratio of at least 2.0 (measured at 0% RH).

In some embodiments, the additive is carbon black, the film comprises 5 to 35 weight percent carbon black, and the film has a beta ratio from 1.5 to 2.5 (measured at 0% RH). In some such embodiments, such a film comprising 5 to 35 weight percent carbon black further comprises a vinyl acetate content of 5 to 30 weight percent, and the film has a beta ratio of at least 2.0 (measured at 0% RH).

In some embodiments, the additive is ethylene vinyl acetate, the film comprises a vinyl acetate content of 10 to 30 weight percent, and the film has a beta ratio from 1.5 to 2.0 (measured at 0% RH).

In some embodiments, the polyolefin comprises one or more polyethylenes such as low density polyethylene, linear low density polyethylene, medium density polyethylene, high density polyethylene, and other ethylene-based polymers having a density from 0.870 g/cm³ to 0.970 g/cm³.

Some embodiments of the present invention relate to methods of making a package. In one embodiment, a method of making a package comprises (a) selecting a polyolefin, the polyolefin comprising polyethylene, polypropylene, polyolefin elastomer, polyolefin plastomer, or a combination thereof; (b) identifying a target beta ratio and a target oxygen permeability for a film; (c) selecting one or more additives based on the target beta ratio and the target oxygen permeability, the one or more additives comprising calcium carbonate, carbon black, ethylene vinyl acetate, or a combination thereof; (d) determining an amount of the selected additive(s) based on the target beta ratio and the target oxygen permeability; (e) forming a film comprising the polyolefin and the selected additive(s), wherein the film has the target beta ratio and the target oxygen permeability; and (f) forming a package comprising at least a portion of the film. In some embodiments, the method further comprises providing a food in the package. In some embodiments, the package is formed entirely from the film. In some embodiments, the polyolefin comprises one or more polyethylenes such as low density polyethylene, linear low density polyethylene, medium density polyethylene, high density polyethylene, and other ethylene-based polymers having a density from 0.870 g/cm³ to 0.970 g/cm³

The film to be made using methods of the present invention comprises a polyolefin. The polyolefins that can be used in methods of the present invention include polyethylene, polypropylene, polyolefin elastomer, polyolefin plastomer, or a combination thereof. As indicated, a wide variety of polyolefins can be used depending on a number of factors including, for example, the desired properties of films to be made, the desired properties of articles or packages to be made from such films, the target beta ratio of the film, the target oxygen permeability of the film, and/or other factors. As indicated, a blend of polyolefins can be used in some embodiments.

In some embodiments, the polyolefin comprises one or more polyethylenes. In some embodiments, the polyethylene has a density of 0.870 g/cm³ or more. All individual values and subranges from equal to or greater than 0.870 g/cm³ are included and disclosed herein; for example the density of the polyethylene can be equal to or greater than 0.870 g/cm³, or in the alternative, equal to or greater than 0.900 g/cm³, or in the alternative, equal to or greater than 0.910 g/cm³, or in the alternative, equal to or greater than 0.915 g/cm³, or in the alternative, equal to or greater than 0.920 g/cm³. The polyethylene has a density equal or less than 0.970 g/cm³. All individual values and subranges from equal to or less than 0.970 g/cm³ are included and disclosed herein. For example, the density of the polyethylene can be equal to or less than 0.970 g/cm³, or in the alternative, equal to or less than 0.960 g/cm³, or in the alternative, equal to or less than 0.955 g/cm³, or in the alternative, equal to or less than 0.950 g/cm³.

In some embodiments, the polyethylene has a melt index (I₂) of 20 g/10 minutes or less. All individual values and subranges up to 20 g/10 minutes are included herein and disclosed herein. For example, the polyethylene can have a melt index from a lower limit of 0.2, 0.25, 0.5, 0.75, 1, 2, 4, 5, 10 or 15 g/10 minutes to an upper limit of 1, 2, 4, 5, 10, or 15 g/10 minutes. The polyethylene has a melt index (I₂) of up to 15 g/10 minutes in some embodiments. The polyethylene has a melt index (I₂) of up to 10 g/10 minutes in some embodiments. In some embodiments, the polyethylene has a melt index (I₂) less than 5 g/10 minutes.

Polyethylenes that are particularly well-suited for use in some embodiments of the present invention include low density polyethylene (LDPE), linear low density polyethylene (LLDPE), medium density polyethylene (MDPE), high density polyethylene (HDPE), other ethylene-based polymers (e.g., enhanced polyethylene) having a density from 0.870 g/cm³ to 0.970 g/cm³ and combinations thereof.

Various commercially available polyethylenes are contemplated for use as polyolefins in some embodiments of the present invention. Examples of commercially available LDPE that can be used in embodiments of the present invention include those available from The Dow Chemical Company under the names DOW LDPE™ and AGILITY™. Examples of commercially available LLDPE that can be used in embodiments of the present invention include DOWLEX™ linear low density polyethylene commercially available from The Dow Chemical Company, such as DOWLEX™ 2045. Examples of commercially available HDPE that can be used in embodiments of the present invention include those available from The Dow Chemical Company under the names DOW™ HDPE resins and DOWLEX™. The polyolefin used in embodiments of the present invention can also include enhanced polyethylenes. Examples of commercially available enhanced polyethylene resins that can be used in embodiments of the present invention include ELITE™ and ELITE™ AT enhanced polyethylenes, such as ELITE™ 5960G1, ELITE™ 5400, and ELITE™ AT 6410 which are commercially available from The Dow Chemical Company. Examples of other polyethylenes that can be used in some embodiments of the present invention are INNATE™ polyethylene resins available from The Dow Chemical Company, such as INNATE™ ST50, INNATE™ ST70, and INNATE™ TH60. Persons of skill in the art can select other suitable commercially available polyethylenes for use in polymer blends based on the teachings herein.

Various commercially available polyolefin elastomers and polyolefin plastomers are contemplated for use as polyolefins in some embodiments of the present invention. Examples of commercially available polyolefin elastomers and polyolefin plastomers that can be used in embodiments of the present invention include those available from The Dow Chemical Company under the names AFFINITY™, VERSIFY™, and ENGAGE™.

Various commercially available polypropylenes are contemplated for use as polyolefins in some embodiments of the present invention. Such polypropylenes can include homopolymer polypropylene (hPP), random copolymer polypropylene (rcPP), impact copolymer polypropylene (hPP+at least one elastomeric impact modifier) (ICPP) or high impact polypropylene (HIPP), high melt strength polypropylene (HMS-PP), isotactic polypropylene (iPP), syndiotactic polypropylene (sPP), and combinations thereof. Examples of commercially available polypropylenes that can be used in embodiments of the present invention include those available from Braskem under the names Inspire 6025 and Inspire 6D20.

In the films formed according to embodiments of the present inventions, the film comprises up to 95 weigh percent polyolefin(s) based on the weight of the films in some embodiments. In some embodiments, the film comprises 60 weight percent or more polyolefin(s) based on the weight of the blend in some embodiments. In some embodiments, the polymer blend comprises 65 weight percent or more polyethylene based on the weight of the blend. In some embodiments, the polymer blend can comprise 60 to 95 wt % polyethylene based on the weight of the blend. All individual values and subranges from 60 to 95 wt % are included and disclosed herein; for example, the amount of polyolefin in the film can be from a lower limit of 60, 65, 70, 75, 80, or 85 wt % to an upper limit of 55, 60, 65, 70, 75, 80, 85, 90, or 95 wt %. For example, the amount of polyolefin in the film can be from 60 to 95 wt %, or in the alternative, from 65 to 95 wt %, or in the alternative, from 80 to 95 wt %, or in the alternative, from 60 to 90 wt %, or in the alternative, from 70 to 90 wt %.

According to embodiments of the present invention, a target beta ratio and a target oxygen permeability is selected for the film. As used herein, the term “beta ratio” refers to the ratio of the permeability of CO₂ through the film (as determined according to ASTM F2476 using a Mocon Permatran-C instrument) to the permeability of O₂ through the film (as determined according to ASTM D-3985 using a Mocon Ox-Trans instrument), with each of the permeabilities being measured at 0% relative humidity. Likewise, the “oxygen permeability” or “oxygen transmission rate” is measured according to ASTM D-3985 using a Mocon Ox-Trans instrument. Unless otherwise stated herein, the permeability of CO₂, the permeability of O₂, and the determination of beta ratio are each measured at 0% relative humidity.

In some embodiments, the target beta ratio is at least 1.5 (measured at 0% RH). The target beta ratio, in some embodiments, is at least 2.0 (measured at 0% RH). In some embodiments, the target beta ratio is from 1.5 to 3.0 (measured at 0% RH). The target beta ratio, in some embodiments, is from 1.5 to 2.5 (measured at 0% RH). In some embodiments, the target beta ratio is from 1.5 to 2.0 (measured at 0% RH).

The target oxygen permeability is dependent on the packaging requirements that will maximize the shelf life of the food item or product that is packaged. For example, some food items may require a high oxygen content in the package to extend shelf life, while others may require a minimal oxygen content. Thus, the oxygen permeabilities of films according to various embodiments can be adjusted to include very high oxygen transmission rate materials (˜12,000 cc/sq.m/atm/day) or very high barrier materials, or intermediate oxygen transmission rate materials.

One or more additives are selected based on the target beta ratio. The one or more additives comprise, consist of, or consist essentially of calcium carbonate, carbon black, ethylene vinyl acetate, or a combination thereof.

In some embodiments, the additive is calcium carbonate. In some embodiments, the calcium carbonate is provided in a carrier resin (i.e., in a master batch) prior to blending with the other polymers, while in other embodiments, the calcium carbonate is added without a carrier resin. Examples of commercially available calcium carbonate that can be used in some embodiments of the present invention include calcium carbonate masterbatches in LLDPE carrier resins from Ampacet Corporation.

In some embodiments, the additive is carbon black. In some embodiments, the carbon black is provided in a carrier resin (i.e., in a master batch) prior to blending with the other polymers, while in other embodiments, the carbon black is added without a carrier resin. Examples of commercially available carbon black that can be used in some embodiments of the present invention include carbon black masterbatches in LLDPE carrier resins from Ampacet Corporation.

In some embodiments, the additive is ethylene vinyl acetate having a vinyl acetate content from 9 to 40%. In some embodiments, the ethylene vinyl acetate has a vinyl acetate content of 9 to 40 weight percent when measured according to ASTM E168. Examples of commercially available ethylene vinyl acetate that can be used in some embodiments of the present invention include ELVAX EVA from DowDuPont.

In some embodiments, at least two additives are provided. In some embodiments, the additives comprise calcium carbonate and ethylene vinyl acetate. The calcium carbonate and ethylene vinyl acetate can be any of those disclosed herein as being useful in some embodiments of the present invention.

In some embodiments, the additives comprise carbon black and ethylene vinyl acetate. The carbon black and ethylene vinyl acetate can be any of those disclosed herein as being useful in some embodiments of the present invention.

The amount of the selected additives are then determined based on the target beta ratio and the target oxygen permeability.

In some embodiments, the selected additive is calcium carbonate, and the target beta ratio is from 1.5 to 3.0. In some embodiments where the selected additive is calcium carbonate, the film comprises 10 to 40 weight percent calcium carbonate, based on the total weight of the film. All individual values and subranges between 10 and 40 weight percent are included herein and disclosed herein. For example, the film can comprise calcium carbonate from a lower weight percent of 10, 15, 17, 20, 22, 25, 27, or 30 weight percent to an upper limit of 20, 23, 24, 25, 28, 30, 32, 34, 35, 38, or 40 weight percent.

In some embodiments, the selected additive is carbon black, and the target beta ratio is from 1.5 to 2.5 (measured at 0% RH). In some embodiments where the selected additive is carbon black, the film comprises 5 to 35 weight percent carbon black, based on the total weight of the film. All individual values and subranges between 5 and 35 weight percent are included herein and disclosed herein. For example, the film can comprise carbon black from a lower weight percent of 5, 8, 10, 15, 17, 20, 22, or 25 weight percent to an upper limit of 20, 23, 24, 25, 28, 30, 32, 34, or 35 weight percent.

In some embodiments, the selected additive is ethylene vinyl acetate, and the target beta ratio is from 1.5 to 2.0 (measured at 0% RH). Persons having ordinary skill in the art recognize that ethylene vinyl acetate is available in a variety of grades with differing vinyl acetate contents. Thus, embodiments of the present invention using ethylene vinyl acetate will be characterized based on the overall vinyl acetate content. In some embodiments where the selected additive is ethylene vinyl acetate, the vinyl acetate content in the film is from 5 to 30 weight percent, based on the total weight of the film. All individual values and subranges between 5 and 30 weight percent are included herein and disclosed herein. For example, the film can comprise ethylene vinyl acetate from a lower weight percent of 5, 7, 9, 10, 15, 17, 20, 22, or 25 weight percent to an upper limit of 20, 23, 24, 25, 28, or 30 weight percent.

In some embodiments, the film comprises calcium carbonate and ethylene vinyl acetate, and the target beta ratio is 2.0 to 3.0 (measured at 0% RH). In some embodiments where the selected additives are calcium carbonate and ethylene vinyl acetate, the film comprises 10 to 40 weight percent calcium carbonate, and the vinyl acetate content of the film is 5 to 30 weight percent, each based on the total weight of the film. In such embodiments, the total amount of calcium carbonate and vinyl acetate in the film is from 15 to 70 weight percent, based on the total weight of the film. The film can comprise calcium carbonate from a lower weight percent of 10, 15, 17, 20, 22, 25, 27, or 30 weight percent to an upper limit of 20, 23, 24, 25, 28, 30, 32, 34, 35, 38, or 40 weight percent, including all individual values and subranges between 10 and 40 weight percent, in various embodiments. The film can have a vinyl acetate content from a lower weight percent of 5, 7, 9, 10, 12, or 15 weight percent to an upper limit of 10, 11, 13, 15, 18, 20, 22, 25, 28, or 30 weight percent, including all individual values and subranges between 5 and 30 weight percent, in various embodiments.

In some embodiments, the film comprises carbon black and ethylene vinyl acetate, and the target beta ratio is 2.0 to 3.0. In some embodiments where the selected additives are carbon black and ethylene vinyl acetate, the film comprises 5 to 35 weight percent carbon black, and the vinyl acetate content of the film is 5 to 30 weight percent, each based on the total weight of the film. In such embodiments, the total amount of carbon black and vinyl acetate in the film is from 15 to 65 weight percent, each based on the total weight of the film. The film can comprise carbon black from a lower weight percent of 5, 8, 10, 15, 17, 20, 22, or 25 weight percent to an upper limit of 20, 23, 24, 25, 28, 30, 32, 34, or 35 weight percent, including all individual values and subranges between 5 and 35 weight percent, in various embodiments. The film can have a vinyl acetate content from a lower weight percent of 5, 7, 9, 10, 12, or 15 weight percent to an upper limit of 10, 11, 13, 15, 18, 20, 22, 25, 28, or 30 weight percent, including all individual values and subranges between 5 and 30 weight percent, in various embodiments.

Methods of the present invention can be used to make monolayer films or multilayer films. Once the composition and structure of the film have been determined (e.g., the polyolefin, the additives, the amount of additives, etc.), the film can be formed using techniques known to those of skill in the art based on the teachings herein.

In some embodiments of multilayer films, the additives are disposed in a single layer. In other embodiments of multilayer films, the additives are disposed in multiple layers. The location of a layer comprising the additive within a multilayer film may depend on other functions that the layer is performing. For example, if the additives are provided in a sealant layer, then the layer would be an outer layer of the film.

In a multilayer film, in addition to the layer or layers comprising the additives that provide the target beta ratio and target oxygen permeability, a multilayer film can further comprise other layers typically included in multilayer films. In some embodiments, a multilayer film can comprise 3 or more layers. A multilayer film, in some embodiments, can comprise up to 11 layers in some embodiments. The number of layers in the film can depend on a number of factors including, for example, the desired thickness of the multilayer film, the desired properties of the multilayer film, the intended use of the multilayer film, and other factors. Examples of other types of layers that can be used in various embodiments depending on the intended application include, for example, sealant layers, polyethylene terephthalate layers, oxygen barrier layers, tie layers, polyethylene layers, polypropylene layers, etc. For example, in one embodiment, the multilayer film is a 3-layer film that comprises a first outer layer comprising a polymer blend including one or more additives to provide a target beta ratio and target oxygen permeability, a second outer layer that is a sealant layer, and a core layer between the first and second outer layers that comprises a blend of ethylene-based polymers (e.g., a blend of LDPE, LLDPE, and/or HDPE).

The films disclosed herein can have a variety of thicknesses depending, for example, on the number of layers, the intended use of the film, and other factors. Monolayer or multilayer films of the present disclosure, in some embodiments, have a thickness of 15 to 200 microns (typically, 30-100 microns). In some embodiments, depending for example on the end use application, the films can be corona treated or printed using techniques known to those of skill in the art

In some embodiments, a monolayer film or multilayer film can further comprise one or more other additives known to those of skill in the art including, for example, antioxidants (e.g., talc, silica, etc.), colorants, slip agents, UV stabilizers, UV absorbers, antiblocks, processing aids, and combinations thereof. In some embodiments, the polymer blend comprises up to 5 weight percent of such additional additives. All individual values and subranges from 0 to 5 wt % are included and disclosed herein; for example, the total amount of additives in the polymer blend can be from a lower limit of 0.5, 1, 1.5, 2, 2.5, 3, 3.5, 4, or 4.5 wt % to an upper limit of 1, 2, 3, 4, or 5 wt %.

In some embodiments, a monolayer film or multilayer film can be oriented either uniaxially or biaxially, depending on the intended use of the film.

In some embodiments, multilayer films of the present invention are non-porous. For example, in some embodiments, a multilayer film comprises less than 5% voids based on volume. In some embodiments, a multilayer film comprises less than 1% voids based on volume. In such embodiments, the percentage of voids in a film on a volume basis are measured as described in A. Sudar et al., The mechanism and kinetics of void formation and growth in particulate filled PE composites, eXPRESS Polymer Letters Vol. 1, No. 11 (2007), pp. 763-772.

The monolayer or multilayer films made according to some embodiments of methods of the present invention may also be used to form laminates according to some embodiments of the present invention. In such embodiments, the monolayer or multilayer film is laminated to another film using an adhesive. The second film can be a variety of other films depending on the intended use of the laminate. Examples of such second films include, without limitation, polyethylene films (e.g., films comprising >95 or >99% polyethylene), polypropylene films, polyethylene terephthalate films, biaxially oriented polyethylene films, biaxially oriented polypropylene films, biaxially oriented polyethylene terephthalate films, and others. Various adhesive compositions are considered suitable for the adhesives used the laminate. These may include polyurethane, epoxy, acrylic, or the like. In one embodiment, the laminate may comprises adhesive layers comprising polyurethane adhesive. The polyurethane adhesive may be solventless, waterborne or solvent based. Furthermore, the polyurethane adhesive may be a two part formulation.

Embodiments of the present invention also relate to methods of making packages. In addition to the aforementioned steps for making films according to embodiments of the present invention, methods of making packages further comprise forming a package comprising at least a portion of the film. Examples of such packages can include flexible packages, pouches, stand-up pouches, pre-made packages or pouches, protective film, agriculture film, wrapping/stretch film, mulching film, silage film, and adhesive film. Such packages can be formed from films using techniques known to those of skill in the art in view of the teachings herein. In some embodiments, the package is formed entirely from the film (e.g., no other films are used to make the package), while in other embodiments, only a portion of the package is formed from the film.

In some embodiments, the package is a food package and the method further comprises providing a food in the package. Examples of foods that can be used in such package include, without limitation, vegetables, fruits, meats, cheeses, and other food products where controlling the food's exposure to oxygen and/or carbon dioxide is important.

### Test Methods

Unless otherwise indicated herein, the following analytical methods are used in describing aspects of the present invention:

### Melt Index

Melt indices I₂ (or I2) and I₁₀ (or I10) were measured in accordance to ASTM D-1238 (method B) at 190° C. and at 2.16 kg and 10 kg load, respectively. Their values are reported in g/10 min.

### Density

Samples for density measurement were prepared according to ASTM D4703. Measurements were made, according to ASTM D792, Method B, within one hour of sample pressing.

Some embodiments of the invention will now be described in detail in the following Examples.

### EXAMPLES

Each of the examples involve monolayer films using DOWLEX™ 2045 (commercially available from The Dow Chemical Company) as the base resin. DOWLEX™ 2045 is a linear low density polyethylene having a density of 0.920 g/cm³ and a melt index (I₂) of 1 g/10 minutes. Comparative Example A and Inventive Examples 1-8 are each extruded into monolayer films having a thickness of 25-30 microns using a Killion blown film extruder under the same conditions.

The beta ratio of each of the films is measured by separately measuring and calculating the ratio of the permeability of CO₂ through the film to the permeability of O₂ through the film. The permeability of CO₂ through the film is determined according to ASTM F2476 using a Mocon Permatran-C instrument at 0% relative humidity. The permeability of O₂ through the film is determined according to ASTM D-3985 using a Mocon Ox-Trans instrument at 0% relative humidity.

Comparative Example A is a monolayer film of DOWLEX™ 2045 with no additives prepared as described above. The Inventive Examples incorporate different additives in different amounts into the monolayer film with DOWLEX™ 2045 as the polyethylene resin, as discussed further below.

### Inventive Examples 1-3

Inventive Examples 1-3 evaluate carbon black as an additive to impact beta ratio. A carbon black masterbatch (50 weight percent carbon black in an LLDPE with an I₂ of 20 g/10 minutes) is physically blended with DOWLEX™ 2045 in various ratios and extruded into monolayer films having thicknesses of 25-30 microns. The CO₂ and O₂ permeabilities are measured, and the beta ratio is calculated. The results are shown in Table 1.

TABLE 1

| | | CO₂ | Beta |
|---|---|---|---|
| | | Permeability | Ratio |
| | | (cm³ · mil)/ | (at 0% |
| Sample | Additive | (m² · day) | RH) |
| Comparative Ex. A | None | 14804 | 1.255 |
| Inventive Ex. 1 | 10 wt. % Carbon Black | 11928 | 1.57 |
| Inventive Ex. 2 | 20 wt. % Carbon Black | 9571 | 1.92 |
| Inventive Ex. 3 | 30 wt. % Carbon Black | 6301 | 1.1 |

As shown in Table 1, the beta ratio for Inventive Example 2 (20 weight % carbon black) is 1.53 times greater than Comparative Example A with no additive. In addition, the CO₂ permeability decreases with increasing content of carbon black.

### Inventive Examples 4-5

Inventive Examples 4-5 evaluate calcium carbonate (CaCO₃) as an additive to impact beta ratio. A calcium carbonate masterbatch (75 weight percent CaCO₃ in an LLDPE with an I₂ of 20 g/10 minutes) is physically blended with DOWLEX™ 2045 in various ratios and extruded into monolayer films having thicknesses of 25-30 microns. The CO₂ and O₂ permeabilities are measured, and the beta ratio is calculated. The results are shown in Table 2.

TABLE 2

| | | CO₂ | Beta |
|---|---|---|---|
| | | Permeability | Ratio |
| | | (cm³ · mil)/ | (at 0% |
| Sample | Additive | (m² · day) | RH) |
| Comparative Ex. A | None | 14804 | 1.255 |
| Inventive Ex. 4 | 19 wt. % CaCO₃ | 20973 | 2.6 |
| Inventive Ex. 5 | 38 wt. % CaCO₃ | 14392 | 2.18 |

As shown in Table 2, the beta ratio for Inventive Example 4 (19 weight % CaCO₃) is over two times greater than Comparative Example A with no additive. In addition, the CO₂ permeability decreases with increasing content of CaCO₃.

### Inventive Examples 6-7

Inventive Examples 6-7 evaluate vinyl acetate as an additive to impact beta ratio. Ethylene vinyl acetate (commercially available from DowDuPont as ELVAX™ 3130 and ELVAX™ 3170 with varying weight percentages of vinyl acetate is extruded into monolayer films having thicknesses of 25-30 microns. The CO₂ and O₂ permeabilities are measured, and the beta ratio is calculated. The results are shown in Table 3.

TABLE 3

| | | CO₂ | Beta |
|---|---|---|---|
| | | Permeability | Ratio |
| | | (cm³ · mil)/ | (at 0% |
| Sample | Additive | (m² · day) | RH) |
| Comparative Ex. A | None | 14804 | 1.255 |
| Inventive Ex. 6 | 12.1 wt. % vinyl acetate | 22330 | 1.8 |
| Inventive Ex. 7 | 18 wt. % vinyl acetate | 24242 | 1.936 |

As shown in Table 3, the beta ratios for Inventive Example 6 and 7 increase with increasing vinyl acetate content relative to Comparative Example A. Of particular note, the CO₂ permeability increases with vinyl acetate content, which is the opposite of what is observed when carbon black and calcium carbonate were used as additives.

### Inventive Example 8

Inventive Example 8 evaluates the use of both carbon black and ethylene vinyl acetate as additives. A carbon black masterbatch (50 weight percent carbon black in an LLDPE with an I₂ of 20 g/10 minutes) and ethylene vinyl acetate are physically blended with DOWLEX™ 2045 extruded into a monolayer film having thicknesses of 25-30 microns. The film has 12 weight percent vinyl acetate and 20 weight percent carbon black. The CO₂ and O₂ permeabilities are measured, and the beta ratio is calculated. The results are shown in Table 4.

TABLE 4

| | | CO₂ | Beta |
|---|---|---|---|
| | | Permeability | Ratio |
| | | (cm³ · mil)/ | (at 0% |
| Sample | Additive | (m² · day) | RH) |
| Comparative Ex. A | None | 14804 | 1.255 |
| Inventive Ex. 6 | 12.1 wt. % vinyl acetate | 22330 | 1.8 |
| Inventive Ex. 8 | 12 wt. % vinyl acetate | 23888 | 2.1 |
| | 20 wt. % carbon black | | |

Table 4 shows that the use of both ethylene vinyl acetate and carbon black as additives allows for the possibility of tuning both beta ratio and CO₂ permeability of a film. In other words, an increase in beta ratio is seen without a corresponding decrease in CO₂ permeability as seen in Inventive Examples 1-3.

1. A method of making a film having a beta ratio and a permeability, the method comprising:
(a) selecting a polyolefin, the polyolefin comprising low density polyethylene, linear low density polyethylene, medium density polyethylene, high density polyethylene, polypropylene, polyolefin elastomer, polyolefin plastomer, or a combination thereof;
(b) identifying a target beta ratio and a target oxygen permeability for the film;
(c) selecting one or more additives based on the target beta ratio, the one or more additives comprising calcium carbonate, carbon black, ethylene vinyl acetate, or a combination thereof;
(d) determining an amount of the selected additive(s) based on the target beta ratio and the target oxygen permeability; and
(e) forming a film comprising the polyolefin and the selected additive(s), wherein the film has the target beta ratio and the target oxygen permeability.

2. The method of claim 1, wherein the film is a multilayer film and the additives are disposed in a single layer.

3. The method of claim 1, wherein the film is a multilayer film and the additives are disposed in at least two layers.

4. The method of claim 1, wherein the film comprises 10 to 40 weight percent calcium carbonate, and wherein the beta ratio is from 1.5 to 3.0.

5. The method of claim 1, wherein the film comprises 5 to 35 weight percent carbon black, and the beta ratio is from 1.5 to 2.5.

6. The method of claim 4, wherein the film further comprises a vinyl acetate content of 5 to 30 weight percent, and wherein the beta ratio is at least 2.0.

7. The method of claim 1, wherein the film comprises a vinyl acetate content of 10 to 30 weight percent, and wherein the beta ratio is from 1.5 to 2.0.

8. A method of making a package, the method comprising:
(a) selecting a polyolefin, the polyolefin comprising low density polyethylene, linear low density polyethylene, medium density polyethylene, high density polyethylene, polypropylene, polyolefin elastomer, polyolefin plastomer, or a combination thereof;
(b) identifying a target beta ratio and a target oxygen permeability for a film;
(c) selecting one or more additives based on the target beta ratio and the target oxygen permeability, the one or more additives comprising calcium carbonate, carbon black, ethylene vinyl acetate, or a combination thereof;
(d) determining an amount of the selected additive(s) based on the target beta ratio and the target oxygen permeability;
(e) forming a film comprising the polyolefin and the selected additive(s), wherein the film has the target beta ratio and the target oxygen permeability; and
(f) forming a package comprising at least a portion of the film.

9. The method of claim 8, further comprising providing a food in the package.

10. The method of claim 8, wherein the package is formed entirely from the film.
